(19) United States
(12) Patent Application Publication
(10) Pub. No.: US 2013/0061173 A1
(43) Pub. Date: Mar. 7, 2013

(54) INFORMATION PROCESSING APPARATUS, CONTROL METHOD THEREOF, AND STORAGE MEDIUM FOR TRANSMITTING A DATA FILE VIA A SHARED FOLDER

(71) Applicant: Makoto Tomita, Kawasaki-shi (JP)

(72) Inventor: Makoto Tomita, Kawasaki-shi (JP)

(73) Assignee: CANON KABUSHIKI KAISHA, Tokyo (JP)

(21) Appl. No.: 13/587,148

(22) Filed: Aug. 16, 2012

(30) Foreign Application Priority Data
Sep. 1, 2011 (JP) 2011-190686

(51) Int. Cl. G06F 3/048; G06F 17/30

(52) U.S. Cl. 715/810

(57) ABSTRACT

An information processing apparatus for storing a data file in an open folder that is monitored to determine whether the data file is stored, the information processing apparatus includes a display control unit configured to display a selection screen for receiving collective selection for a plurality of the open folders generated in a shared folder that can be browsed by a plurality of information processing apparatuses; a selection unit configured to select the plurality of open folders received via the selection screen displayed by the display control unit, and a registration unit configured to register the plurality of open folders selected by the selection unit as transmission destinations.

### BACKGROUND OF THE INVENTION

1. Field of the Invention

The present invention relates to processing for controlling display of a user interface when a transmission destination of a transmission-side program is registered in a document processing system for transmitting/receiving a data file via a shared folder.

2. Description of the Related Art

Generally, when data file is transmitted/received between programs operated on two different personal computers (PCs), the data file is transmitted/received via a specific folder that can be browsed by the two programs (as discussed in e.g., Japanese Patent Application Laid-Open No. 2000-118095). More specifically, a reception-side program monitors the data file to be generated in the specific folder, and the transmission-side program transmits the data file to the specific folder that is monitored. When the transmission-side program transmits the data file to the monitored folder, the reception-side program executes processing for receiving the data file.

According to the conventional technique, however, to transmit and receive the data file via the folder, both of the transmission and reception sides need to specify the same folder, but, normally, a person using the transmission-side program and a person using the reception-side program are normally different. Thus, setting the folder requires a special attention. Further, when there are a plurality of addresses to be transmitted to, a similar setting needs to be repeatedly performed for each combination of the transmission and reception sides, thereby increasing setting workloads.

### SUMMARY OF THE INVENTION

According to an aspect of the present invention, an information processing apparatus for storing a data file in an open folder that is monitored to determine whether the data file is stored includes a display control unit configured to display a selection screen for receiving collective selection for a plurality of the open folders generated in a shared folder that can be browsed by a plurality of information processing apparatuses, a selection unit configured to select the plurality of open folders received via the selection screen displayed by the display control unit, and a registration unit configured to register the plurality of open folders selected by the selection unit as transmission destinations.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a hardware configuration of a PC according to an exemplary embodiment of the present invention.

FIG. 2 illustrates a software configuration of the PC according to the exemplary embodiment of the present invention.

FIG. 3 illustrates a software configuration of the PC according to the exemplary embodiment of the present invention.

FIG. 4 illustrates a system configuration of a document processing system according to the exemplary embodiment of the present invention.

FIG. 5 is a flowchart illustrating a reception setting according to the exemplary embodiment of the present invention.

FIG. 6 is a flowchart illustrating the reception setting according to the exemplary embodiment of the present invention.

FIG. 7 is a flowchart illustrating the reception setting according to the exemplary embodiment of the present invention.

FIG. 8 is a flowchart illustrating processing for registering a transmission destination according to the exemplary embodiment of the present invention.

FIG. 9 is a flowchart illustrating processing for registering a transmission destination according to the exemplary embodiment of the present invention.

FIG. 10 illustrates an example of a dialog box displayed when reception is set according to the exemplary embodiment of the present invention.

FIGS. 11A and 11B each illustrate an example of a folder structure of a shared file server with the reception setting according to the exemplary embodiment of the present invention.

FIG. 12A illustrates an example of a file management user interface (UI) before the reception setting according to the exemplary embodiment of the present invention. FIG. 12B illustrates an example of a file management UI after the reception setting to the exemplary embodiment of the present invention.

FIG. 13 illustrates an example of a dialog box for registering a transmission destination according to the exemplary embodiment of the present invention.

FIG. 14 illustrates an example of a file management UI according to the exemplary embodiment of the present invention.

FIG. 15 illustrates an example of a dialog box for an error message indicative of overlapping open names according to the exemplary embodiment of the present invention

FIG. 16 illustrates an example of a data format of a reception information file according to the exemplary embodiment of the present invention.

### DESCRIPTION OF THE EMBODIMENTS

Various exemplary embodiments, features, and aspects of the invention will be described in detail below with reference to the drawings.

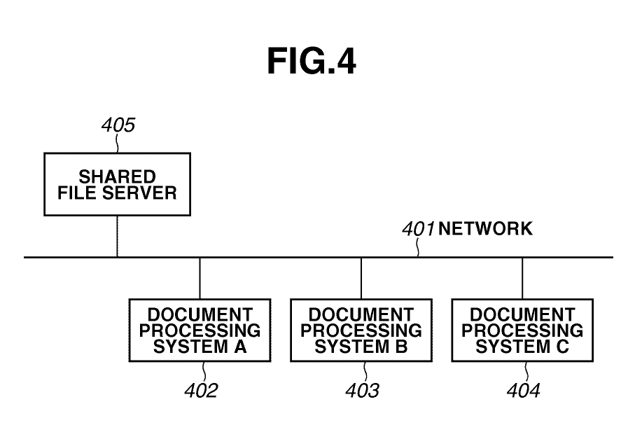

FIG. 4 illustrates a configuration of a system according to a first exemplary embodiment of the present invention. According to the present exemplary embodiment, a typical information processing apparatus (PC) realizes all functions of a document processing system.

A system according to the present exemplary embodiment includes a shared file server 405 connected to a network 401, and document processing systems 402, 403, and 404 monitoring a predetermined folder on the shared file server 405 and waiting to receive a data file. Further, the document processing systems 402, 403, and 404 also have a function of transmitting the data file to a predetermined folder on the shared file server 405. According to the present exemplary embodiment, the shared file server 405 will be described as an independent server. However, the present invention can also be applied when a shared folder included on the PC where the document processing systems are operated is used. Furthermore, according to the present exemplary embodiment, to simplify descriptions, a case where three document processing systems are used will be described. However, the present invention can be also applied when more or less than three document processing systems are used.

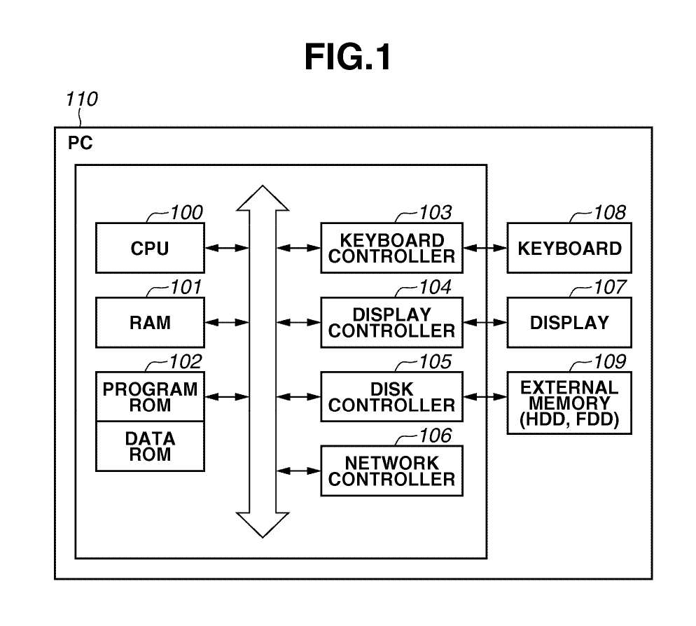

FIG. 1 illustrates a hardware configuration of a PC included in a document processing system according to the exemplary embodiment of the present invention. The hardware configuration illustrated in FIG. 1 corresponds to that of a typical PC, and the hardware configuration of the typical PC can be applied to a PC 110 according to the present exemplary embodiment.

As illustrated in FIG. 1, a central processing unit (CPU) 100 executes a program of an operating system (OS) and an application loaded from a program read only memory (ROM) of a ROM 102 or a hard disk 109 to a random access memory (RAM) 101. Processing performed according to each flowchart described below can be realized when the CPU 100 reads a program related to the flowchart from the memory and executes the program. The RAM 101 functions as a main memory and a work area of the CPU 100. A keyboard controller 103 controls input performed via a pointing device (not illustrated) such as a keyboard 108 and a mouse. A display controller 104 controls display performed via each display 107. A disk controller 105 controls data to access a hard disk (HDD) 109 or a floppy disk (FDD) storing various kinds of data. A network controller 106 is connected to a network to perform communication control processing with other devices connected thereto.

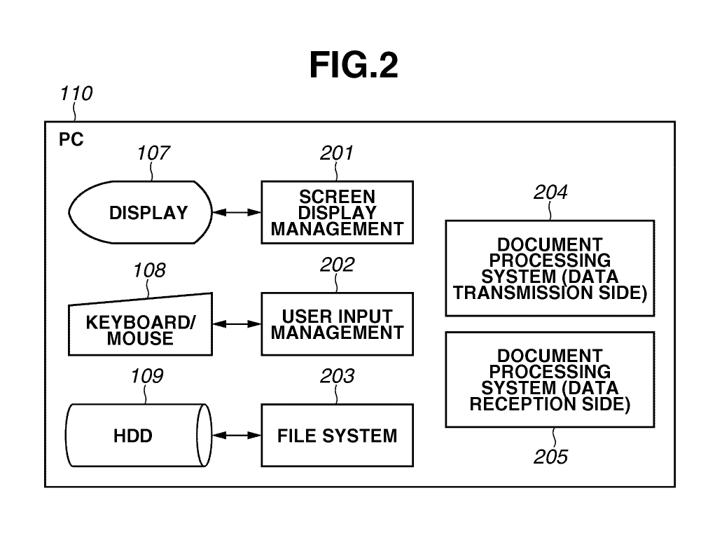

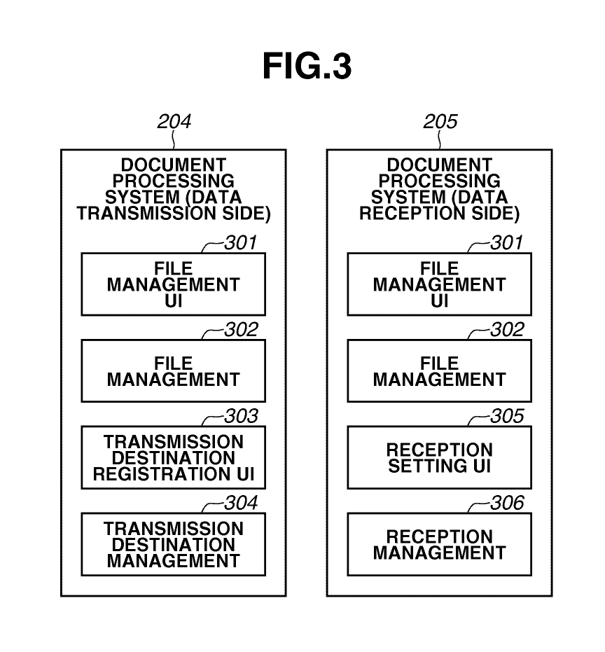

FIGS. 2 and 3 illustrate software configurations of the PC included in the document processing system according to the exemplary embodiment of the present invention. The document processing system according to the present exemplary embodiment can be realized by a program executing all functions on the PC 110 as described for the hardware configuration.

The PC 110 includes a document processing system 204 transmitting the data file, a document processing system 205 receiving the data file, and a file system 203 storing and acquiring information on the hard disk 109 as the data file.

The PC 110 includes a user input management module 202 giving an instruction to the document processing systems 204 and 205 according to user's operation performed via the keyboard/mouse 108, and a screen display management module 201 displaying an operation result of the document processing systems 204 and 205.

A file management UI module 301 in the document processing system 204 displays a state of the data file managed by the file management module 302 and the transmission destination managed by a transmission-destination management module 304. Further, the file management UI module 301 gives to the file management module 302 an instruction for operating the data file of the document according to the operation of the user input management module 202.

The file management module 302 manages the document as the data file, and operates the data file of the document according to the instruction for operating the file from the file management UI module 301.

The transmission-destination management module 304 registers and stores the transmission destination of the data file.

A transmission-destination registration UI module 303 displays the UI for registering the transmission destination, and gives to the transmission-destination management module 304 an instruction for registering the transmission destination according to the operation of the user input management module 202.

The file management UI module 301 in the document processing system 205 displays a state of the data file managed by the file management module 302 shared with the data-file transmission side, and also displays file reception information managed by a reception management module 306. Further, the file management UI module 301 gives to the file management module 302 an instruction for operating the data file of the document according to the operation of the user input management module 202. The file management UI module 301 is shared between the document processing system 204 and the document processing system 205. The file management module 302 is also shared between the document processing system 205 and the document processing system 204.

The reception management module 306 monitors whether the data file has been received and, when the data file is received, gives to the file management UI module 301 an instruction for displaying a new-arrival notification screen.

A reception setting UI module 305 displays the UI for setting the reception, and gives to the reception management module 306 an instruction for registering a reception setting according to the operation of the user input management module 202.

In the present exemplary embodiment, it is described that the document processing systems 204 and 205 function as the transmission side and the reception side respectively to simplify the description. However, each document processing system actually has both functions of the transmission and reception, and thus can exchange the data file with each other. In such a case, the present invention can be also applied.

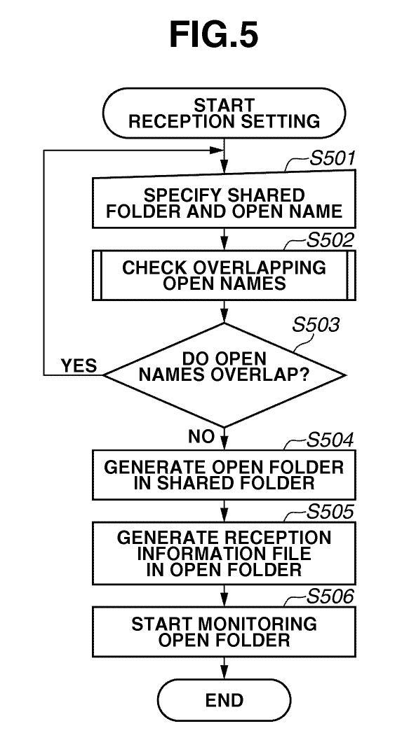

With reference to software configurations illustrated in FIGS. 2 and 3 and the system configuration illustrated in FIG. 4, flowcharts illustrated in FIGS. 5 to 9, and FIGS. 10 to 16, processing according to the exemplary embodiments of the present invention will be described.

When the document processing systems A 402, B 403, and C 404 each receive the data file in the system illustrated in FIG. 4, the reception-setting information about the data file needs to be set for each document processing system. Prior to setting the information, it needs to be previously determined to use the shared folder which can be accessed by each user using the document processing systems A 402, B 403, and C404, as a folder to be used for the transmission/reception. In the present exemplary embodiment, such a shared folder will be described as a folder of “¥¥FileServer¥SharedFolder” on the shared file server 405.

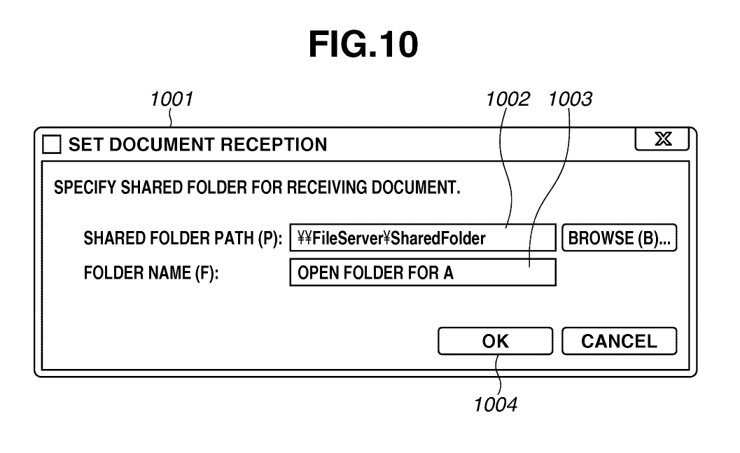

In the document processing system 205 on the PC 110 included in the document processing system A 402, the user starts setting the reception-setting information via the file management UI using the keyboard/mouse 108. When the setting is started, the user input management module 202 detects the operation with the keyboard/mouse 108, and then gives an instruction about the operation content to the document processing system 205. The document processing system 205 receiving the instruction uses the reception setting UI module 305 to display a dialog box of “SET DOCUMENT RECEPTION” 1001 (a setting screen) illustrated in FIG. 10, and set the reception-setting information. The reception-setting information includes a path of the shared folder and an open name of the folder. Based on the set reception-setting information, the document processing system 205 generates an open folder having the open name specified in the path of the specified shared folder.

In step S501, the reception setting UI module 305 receives a shared folder path of “¥¥FileServer¥SharedFolder” 1002 and an open name of “OPEN FOLDER FOR A” 1003 that are input by the user via the dialog box of “SET DOCUMENT RECEPTION” 1001.

In step S502, the reception setting UI module 305 performs an overlap check to determine whether the path of the specified shared folder includes open folders having the same open name.

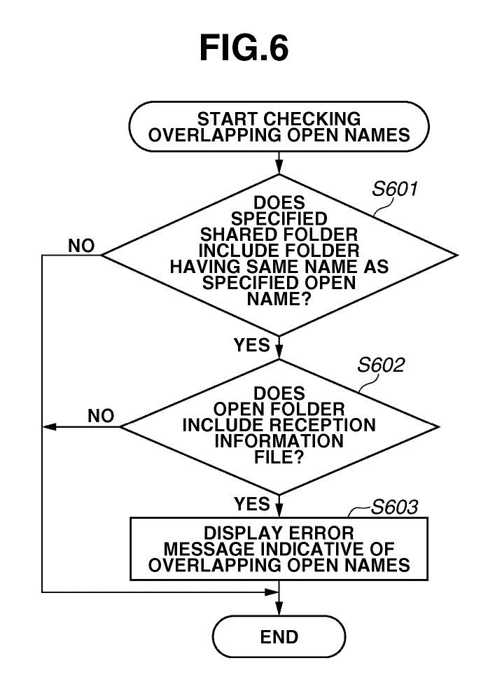

The overlap check of the open name will be described in detail with reference to FIG. 6. In step S601, the reception setting UI module 305 determines whether the shared folder path of “¥¥FileServer¥SharedFolder” 1002 includes a folder having the same name as the open name of “OPEN FOLDER FOR A” 1003.

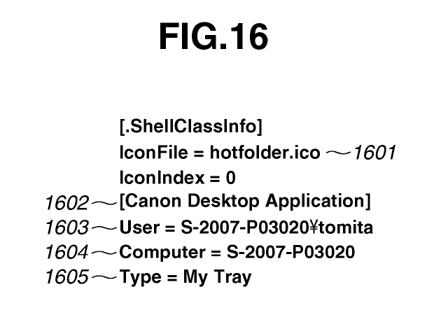

When it is determined that the shared folder path specified in step S601 includes the folder having the same open name as the open name specified via the dialog box illustrated in FIG. 10, then in step S602, the reception setting UI module 305 determines whether the folder (existing folder) having the same name as the open name of “OPEN FOLDER FOR A” 1003 includes a reception information file 1601 illustrated in FIG. 16.

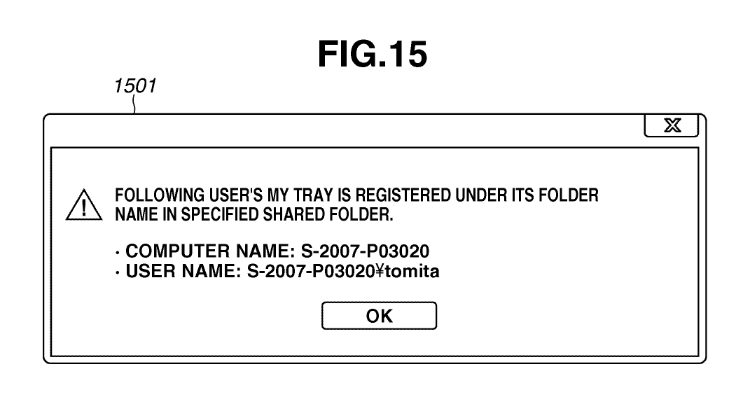

When it is determined that the folder having the same name as the open name of “OPEN FOLDER FOR A” 1003 includes the reception information file 1601 (YES in step S601), the open names overlap each other. Thus, in step S603, the reception setting UI module 305 displays an error message indicative of overlapping open names illustrated in FIG. 15. According to the example, based on computer name information 1604 and user name information 1603 recorded in an existing reception information file 1601, the dialog box illustrated in FIG. 15 displays which user sets the folder that has been opened under the same name. Even when it is determined “YES” in step S601, if the folder (existing folder) having the same name of the open name of “OPEN FOLDER FOR A” 1003 does not include the reception information file 1601, the folder is not the open folder. Such a folder has no problem with overlapping open names, and thus the processing in step S603 is not performed.

Referring back to FIG. 5, when it is determined that the open names overlap in step S503 based on a check result in step S502 (YES in step S503), the shared folder path of “¥¥FileServer¥SharedFolder” 1002 and the open name of “OPEN FOLDER FOR A” 1003 are input by the user again.

When it is determined that the open names do not overlap based on the check result in step S502 (NO in step S503), then in step S504, the reception setting UI module 305 generates the folder having the open name of “OPEN FOLDER FOR A” 1003 in the shared folder path of “¥¥FileServer¥SharedFolder” 1002 as the open folder.

In step S505, based on the computer name information 1604 of the PC 110 included in the document processing system A 402 and the user name information 1603, the reception setting UI module 305 generates the reception information file 1601. The generated reception information file 1601 is stored in the open folder generated in step S504.

In step S506, the reception setting UI module 305 gives to the reception management module 306 an instruction for starting the reception, and then the reception management module 306 starts monitoring the open folder to determine whether the open folder receives the file.

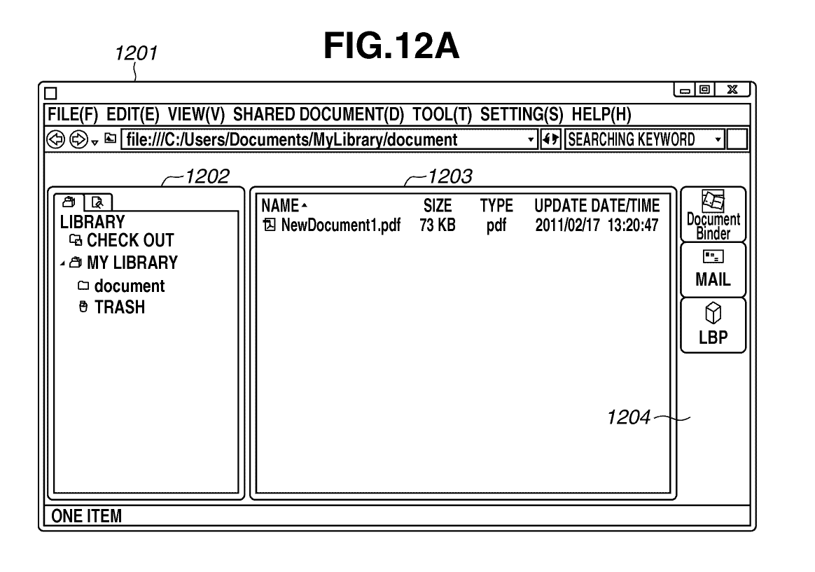

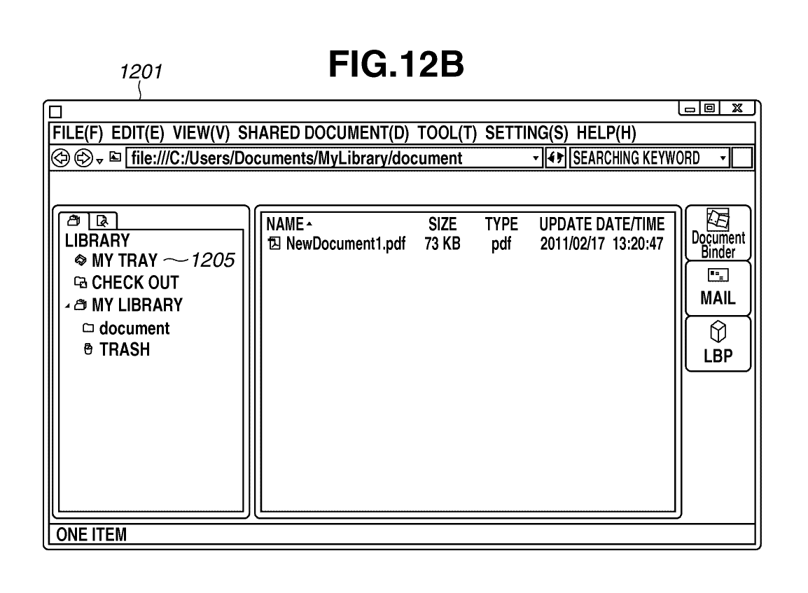

FIGS. 12A and 12B illustrate examples of the file management UI before and after the open folder is generated, when the document processing system A 402 performs the processing illustrated in FIGS. 5 and 6. When the open folder is generated by performing the processing illustrated in FIGS. 5 and 6, a file tree display UI 1202 displays an open folder 1205 displayed as “MY TRAY”. Subsequently, when the data file is stored in the open folder, the reception management module 306 monitoring the open folder detects generation of the data file, and then the file management UI module 301 displays the new-arrival notification screen.

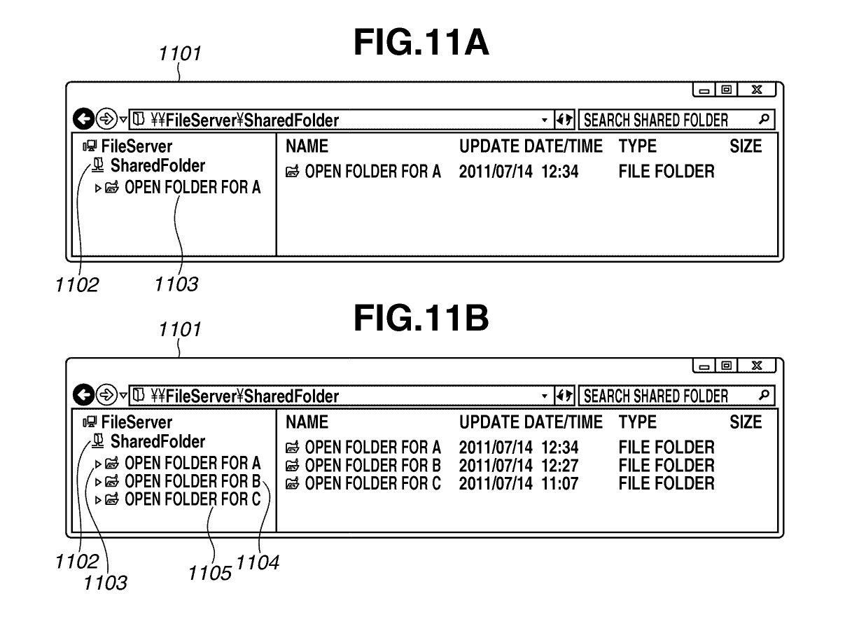

FIG. 11A schematically illustrates a folder structure of the shared file server 405 in a state where only the document processing system A 402 generates the open folder in the shared folder on the shared file server 405.

Right below “SharedFolder” of “¥¥FileServer¥SharedFolder” 1102 used for the transmission and reception, “OPEN FOLDER FOR A” 1103 having the same folder name as the open name of “OPEN FOLDER FOR A” 1003 is generated. Similarly, FIG. 11B schematically illustrates the folder structure of the shared file server 405 in a state where the document processing systems B 403 and C 404 also generate the open folders on the shared file server 405. Right below the “SharedFolder” of “¥¥FileServer¥SharedFolder” 1102 used for the transmission and reception, “OPEN FOLDER FOR A” 1103, “OPEN FOLDER FOR B” 1104, and “OPEN FOLDER FOR C” 1105 generated by the document processing systems A 402, B 403, and C404 respectively are included.

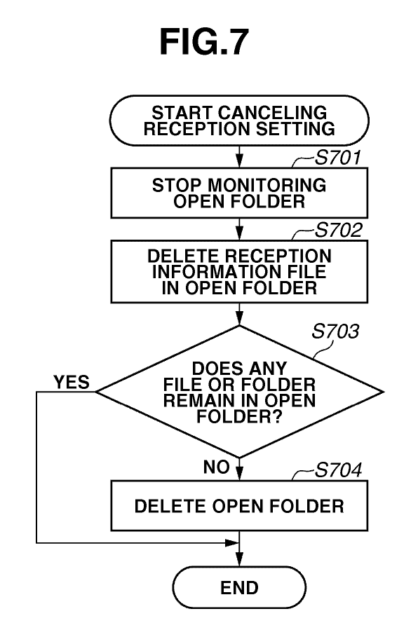

FIG. 7 is a flowchart illustrating processing performed when the document processing system 205 that has generated the open folder cancels the reception in the open folder. When the user performs a reception cancel operation on the open folder via the file management UI, then in step S701, the reception management module 306 stops monitoring the open folder to determine whether the open folder receives the file. Subsequently, in step S702, the user deletes the reception information file 1601 in the open folder. Further, in step S703, the reception management module 306 determines whether the data file or the folder remains in the open folder. When no data file or folder remains (NO in step S703), then in step S704, the open folder is deleted. On the other hand, when the data file or the folder remains in the open folder (YES in step S703), the deletion of the open folder is kept pending since the transmission and reception has not been completed yet.

Subsequently, registration of the transmission destination when the data file is transmitted from the document processing system A 402 to the document processing systems B 403 and C 404 in the system illustrated in FIG. 4 will be described.

In the document processing system 204 on the PC 110 included in the document processing system A 402, the user starts registering the transmission destination via the file management UI using the keyboard/mouse 108. With the user's operation, the user input management module 202 detects the operation performed with the keyboard/mouse 108, and gives the operation content to the document processing system 204.

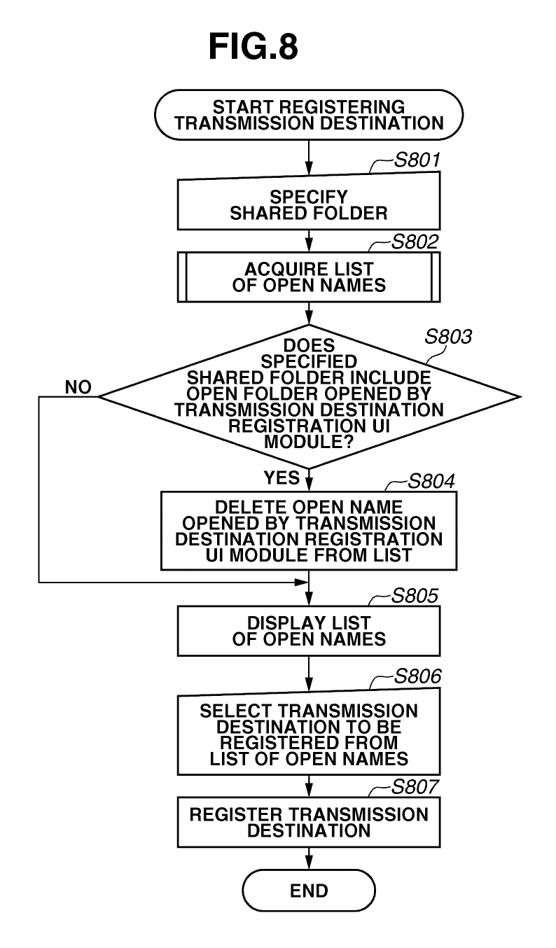

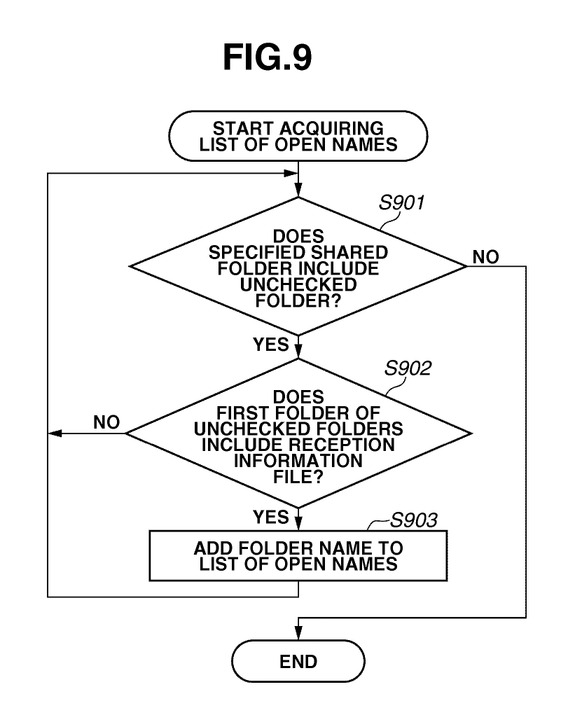

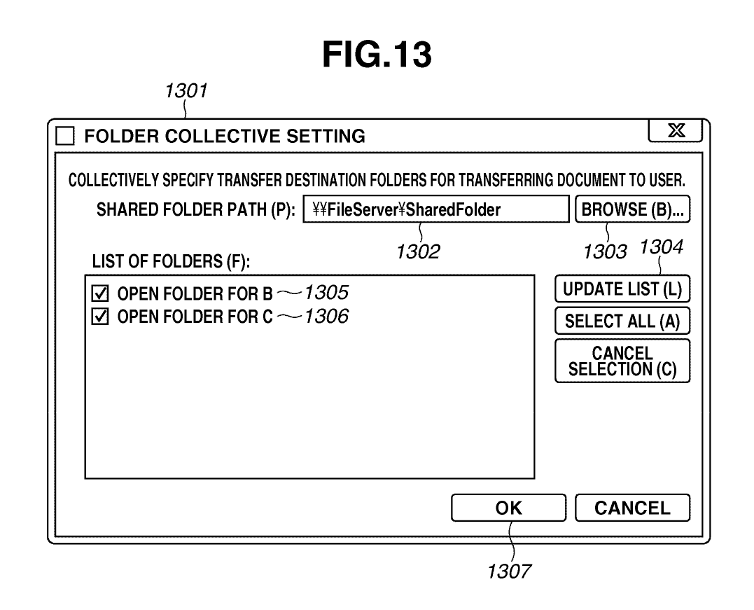

The document processing system 204 that has received the instruction displays a dialog box of “FOLDER COLLECTIVE SETTING” 1301 illustrated in FIG. 13 using the transmission-destination registration UI module 303, and then collectively selects and registers a plurality of transmission destinations according to the flowchart illustrated in FIGS. 8 and 9.

In step S801, the transmission-destination registration UI module 303 receives the input of a shared folder path of “¥¥FileServer¥SharedFolder” 1302 from the user via the dialog box of “FOLDER COLLECTIVE SETTING” 1301. At this point, the user may select the shared folder via a “BROWSE” button 1303, or may directly input the share folder path of “¥¥FileServer¥SharedFolder” 1302, and then may press a check button 1304.

In step S802, the transmission-destination registration UI module 303 acquires a list of the open names of the open folders.

With reference to FIG. 9, the processing performed in step S802 will be described in detail. In step S901, the transmission-destination registration UI module 303 sequentially checks the folders included in the shared folder of the shared folder path of “¥¥FileServer¥SharedFolder” 1302, and then in step S902, the transmission-destination registration UI module 303 determines whether the folder to be checked includes the reception information file.

In step S903, the transmission-destination registration UI module 303 adds the folder name of the folder including the reception information file to the list of the open names.

In step S803, the transmission-destination registration UI module 303 determines whether the shared folder specified in step S801 includes the open folder opened by the transmission-destination registration UI module 303. When it is determined that the shared folder includes the open folder (YES in step S803), then instep S804, the open name of the open folder opened by the transmission-destination registration UI module 303 is deleted from the list of the open names generated in step S903. If the open folder opened by the transmission-destination registration UI module 303 is not selected as the transmission destination, no problem occurs. Thus, even if it is deleted from selection candidates, it may be displayed in gray not to be selected as the selection candidate. In step S803, the transmission-destination registration UI module 303 determines that the open folder including the reception information file corresponding to the information about the PC on which the document processing system is operated is the open folder opened by the transmission-destination registration UI module 303. The processing will be described with reference to FIG. 8 again.

In step S805, the transmission-destination registration UI module 303 executes display control processing for displaying the list of the open names (open names 1305 and 1306) so that the open name can be selected via the dialog box of “FOLDER COLLECTIVE SETTING” 1301 (selection screen) illustrated in FIG. 13. In step S806, the transmission-destination registration UI module 303 receives the selection of the folder to be registered as the transmission destination from the user. At this point, the transmission-destination registration UI module 303 can receive collective selection for a plurality of transmission destinations from the user. The transmission-destination registration UI module 303 may receive one selection for the transmission destination from the user.

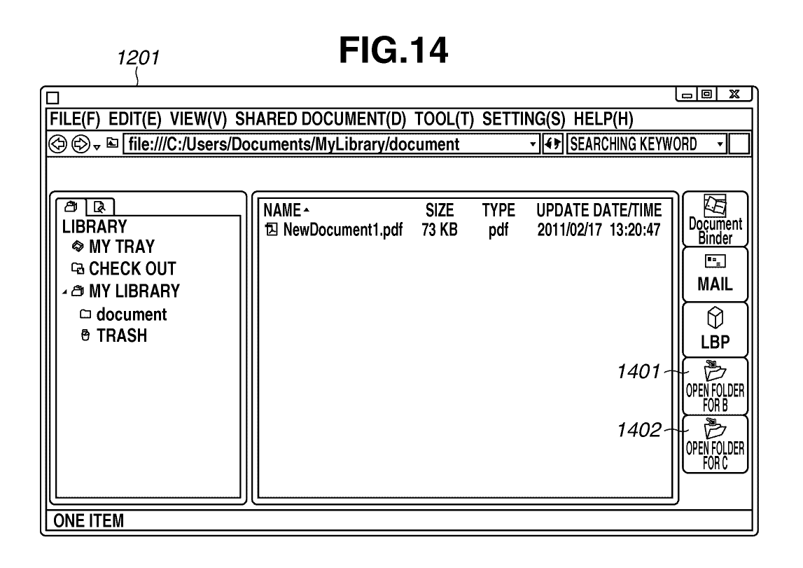

Subsequently, in step S807, the transmission-destination registration UI module 303 registers the shared folder of the transmission destination using the transmission-destination management module 304. With this registration, the transmission-destination management module 304 gives to the file management UI module 301 an instruction for displaying the transmission destination in a transmission destination region 1204. FIG. 14 illustrates an example of the file management UI displayed by the file management UI module 301. When the user selects the plurality of open folders 1305 and 1306 as the transmission destination from the list of the open names, the plurality of transmission destinations 1401 and 1402 are displayed.

By performing the above-described processing, the user interface related to the registration of the transmission destination of the transmission-side program can be controlled to list up the reception-side programs that can be received according to a setting state of the open folders of the reception-side program. Therefore, the plurality of transmission destinations can be correctly registered at a time.

According to the first exemplary embodiment, the folder used for the transmission/reception between the document processing system 204 of a data-transmission side and the document processing system 205 of a data-reception side has the open name of “OPEN FOLDER FOR A” 1103 which is the same name as the open name of “OPEN FOLDER FOR A” 1003 generated right below the “SharedFolder” of “¥¥FileServer¥SharedFolder” 1102. However, when address information is included as additional information of the data file to be transmitted, the “SharedFolder” of “¥¥FileServer¥SharedFolder” 1102 may be used. According to a second exemplary embodiment, only difference from the first exemplary embodiment in a flow of UI control in the document processing system will be described.

In such a case, in the registration processing of the open folder illustrated in FIGS. 5 and 6, the processing for generating the open folder is not performed. More specifically, the processing of step S601 for determining whether a folder having the same name as the open name of “OPEN FOLDER FOR A” 1003 is included in the folder in the shared folder path of “¥¥FileServer¥SharedFolder” 1002 and the processing of step S504 for generating the folder having the open name of “OPEN FOLDER FOR A” 1003 as the open folder in the shared folder path of “¥¥FileServer¥SharedFolder” 1002 are not performed.

In step S505, the reception information file 1601 generated based on the computer name information 1604 of the PC 110 included in the document processing system A 402 and the user name information 1603 is stored under the same name as the open name of “OPEN FOLDER FOR A” 1003 in the folder in the shared folder path of “¥¥FileServer¥SharedFolder” 1002, instead of in the open folder.

Further, in the processing performed when the reception setting is canceled as illustrated in FIG. 7, the processing performed in step S702 for deleting the reception information file 1601 in the open folder is not performed, but the reception information file 1601 having the same name as the open name of “OPEN FOLDER FOR A” 1003 in the folder in the shared folder path of “¥¥FileServer¥SharedFolder” 1002 is deleted. The processing of step S703 for determining whether the data file or the folder remains in the open folder and the deletion processing of step S704 are not performed.

In the processing for registering the transmission destination, in the processing for acquiring the list of the open names illustrated in FIG. 9, the check performed in steps S901 and S902 is not performed for the folder included in the shared folder path of “¥¥FileServer¥SharedFolder” 1302, but the reception information file included in the shared folder path of “¥¥FileServer¥SharedFolder” 1302 is sequentially checked. Further, the folder name of the folder included in the reception information file is not added to the list of the open names in step S903, but the file name of the reception information file is added to the list of the open names.

Other processing than the above-described processing is performed similarly to the first exemplary embodiment, and thus the “SharedFolder” of “¥¥FileServer¥SharedFolder” 1102 can be used as the open folder.

As described above, according to the present exemplary embodiment, the plurality of transmission destinations can be also collectively registered, thereby improving user's operability. According to the present exemplary embodiment, the operability of registering the transmission destination can be improved.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-190686 filed Sep. 1, 2011, which is hereby incorporated by reference herein in its entirety.

What is claimed is:

1. An information processing apparatus for storing a data file in an open folder that is monitored to determine whether the data file is stored, the information processing apparatus comprising:
a display control unit configured to display a selection screen for receiving collective selection for a plurality of the open folders generated in a shared folder that can be browsed by a plurality of information processing apparatuses;
a selection unit configured to select the plurality of open folders received via the selection screen displayed by the display control unit; and
a registration unit configured to register the plurality of open folders selected by the selection unit as transmission destinations.

2. The information processing apparatus according to claim 1, wherein the display control unit is configured to display the selection screen on which an open folder registered by the information processing apparatus that registers the transmission destination is removed from selection by the selection unit.

3. The information processing apparatus according to claim 1, wherein the display control unit is configured to display the selection screen displaying a folder, as a selection candidate, that stores a reception information file indicating the reception information file to be used as the open folder in the shared folder.

4. The information processing apparatus according to claim 1, wherein the open folder is generated based on a path of the shared folder and a name of the open folder that have been input via a setting screen.

5. A control method for storing a data file in an open folder that is monitored to determine whether the data file is stored, the control method comprising:
displaying on a display device a selection screen for receiving collective selection for a plurality of open folders generated in a shared folder that can be browsed by a plurality of information processing apparatuses;
receiving selection for the plurality of open folders received via the selection screen displayed on the display device; and
registering the plurality of open folders that have been selected as transmission destinations.

6. The control method according to claim 5, further comprising displaying the selection screen on which an open folder registered by the information processing apparatus that registers the transmission destination is removed from selection by the receiving selection step.

7. The control method according to claim 5, further comprising displaying the selection screen displaying a folder, as a selection candidate, that stores a reception information file indicating the reception information file to be used as the open folder in the shared folder.

8. The control method according to claim 5, wherein the open folder is generated based on a path of the shared folder and a name of the open folder that have been input via a setting screen.

9. A storage medium storing a program that causes a computer for storing a data file in an open folder that is monitored to determine whether the data file is stored, to function as:
a display control unit configured to display a selection screen for receiving collective selection for a plurality of the open folders generated in a shared folder that can be browsed by a plurality of information processing apparatuses;
a selection unit configured to select the plurality of open folders received via the selection screen displayed by the display control unit; and
a registration unit configured to register the plurality of open folders selected by the selection unit as transmission destinations.

10. The storage medium according to claim 9, wherein the display control unit is configured to display the selection screen on which an open folder registered by the information processing apparatus that registers the transmission destination is removed from selection by the selection unit.

11. The storage medium according to claim 9, wherein the display control unit is configured to display the selection screen displaying a folder, as a selection candidate, that stores a reception information file indicating the reception information file to be used as the open folder in the shared folder.

12. The storage medium according to claim 9, wherein the open folder is generated based on a path of the shared folder and a name of the open folder that have been input via a setting screen.
